(19) United States
(12) Patent Application Publication
(10) Pub. No.: US 2025/0099319 A1
(43) Pub. Date: Mar. 27, 2025

(54) Low-Noise Electromagnetic Valve Assembly, Air Bag Massage Device, and Control Method

(71) Applicant: DEWERTOKIN TECHNOLOGY GROUP CO., LTD., Jiaxing, Zhejiang (CN)

(72) Inventors: Jiajun WU, Jiaxing, Zhejiang (CN); Kai FANG, Jiaxing, Zhejiang (CN); Wei WU, Jiaxing, Zhejiang (CN)

(21) Appl. No.: 18/725,773

(22) PCT Filed: Sep. 29, 2022
(86) PCT No.: PCT/CN2022/122794

§ 371 Date: Jun. 30, 2024

(30) Foreign Application Priority Data
Dec. 31, 2021 (CN) 202123424514.4

(51) Int. Cl. A61H 9/00

(52) U.S. Cl. CPC A61H 9/0078; A61H 2201/0169; A61H 2201/1207

(57) ABSTRACT

Disclosed are a low-noise electromagnetic valve assembly, an air bag massage device, and a Control Method. The low-noise electromagnetic valve assembly includes an electromagnetic valve body, a flow guide piece, and a silencer; and the flow guide piece includes an air intake interface, an air release interface, an air bag interface, and a reserved interface The electromagnetic valve body enables the air bag interface to be in communication with the air intake interface or the air release interface, and the reserved interface is in communication with the air bag interface. The air release interface is in communication with the silencer, and the silencer is provided with a silencing air outlet. The low-noise electromagnetic valve assembly, the air bag massage device, and the control method can solve the problems of high production cost and poor usage experience of an electromagnetic valve.

### CROSS-REFERENCE TO RELATED APPLICATION

The present application claims priority to Chinese Patent Application No. 202123424514.4, filed to the China National Intellectual Property Administration on Dec. 31, 2021 and entitled “Low-Noise Electromagnetic Valve Assembly, Air Bag Massage Device, and Control Method”, the disclosure of which is hereby incorporated by reference in its entirety.

### TECHNICAL FIELD

The present disclosure relates to the technical field of massage device, and in particular to a low-noise electromagnetic valve assembly, an air bag massage device, and a control method.

### BACKGROUND

Electric sofas, massage chairs, and electric beds having pneumatic massage systems can perform pneumatic massage. The pneumatic massage system includes a plurality of air bags, an air pump, and a plurality of electromagnetic valves. The plurality of electromagnetic valves are in one-to-one correspondence with the plurality of air bags, and the air pump respectively inflates or deflates the plurality of air bags by the plurality of electromagnetic valves, so as to change the heights of the plurality of air bags, thereby achieving the effect of pneumatic massage. Each of the existing electromagnetic valves is provided with an air release interface, the air release interfaces of the plurality of electromagnetic valves perform deflation together, and the deflation sound is too large to affect the usage experience. A silencer is correspondingly arranged at each air release interface, so that the production cost is increased, and a plurality of silencers are arranged, so that the volume of the pneumatic massage system is too large.

### SUMMARY

The present disclosure provides a low-noise electromagnetic valve assembly, an air bag massage device, and a control method, so as to solve the problems of high production cost and poor usage experience of an electromagnetic valve in related technologies.

According to one aspect of the present disclosure, a low-noise electromagnetic valve assembly is provided, which includes an electromagnetic valve body, a flow guide piece, and a silencer. The flow guide piece is connected with the electromagnetic valve body, and the flow guide piece includes an air intake interface, an air release interface, an air bag interface, and a reserved interface. The air intake interface can be in communication with an air pump, the air bag interface is in communication with an air bag, the electromagnetic valve body is configured to enable the air bag interface to be in communication with the air intake interface or the air release interface, the reserved interface can be in communication with the air bag interface, and the reserved interface is configured for air release. The air release interface is in communication with the silencer, the silencer is provided with a silencing air outlet, and the silencer is configured to reduce air release noise.

Further, an intake line is arranged in the flow guide piece, the intake line can be in communication with the air bag interface and the air intake interface, and gas can flow into the air bag through the air intake interface, the intake line, and the air bag interface.

Further, an exhaust line is arranged in the flow guide piece, the exhaust line can be in communication with the air bag interface and the air release interface, and gas in the air bag can flow out through the air bag interface, the exhaust line, and the air release interface.

Further, the silencer includes a housing and silencer cotton. A silencer chamber is arranged in the housing, the air release interface is in communication with the silencer chamber, and the housing is provided with the silencing air outlet. The silencer cotton is arranged in the silencer chamber.

Further, the housing is provided with a silencing air inlet, and the air release interface is in communication with the silencer chamber through the silencing air inlet.

Further, buffer holes are respectively formed in the silencing air inlet and the silencing air outlet, and the buffer holes are configured to enable the gas to smoothly flow out.

Further, the flow guide piece is detachably connected with the electromagnetic valve body through a connecting piece.

Further, a first mounting hole is formed in the flow guide piece, a second mounting hole is formed in the electromagnetic valve body, and the connecting piece passes through the first mounting hole and the second mounting hole.

Further, the flow guide piece includes a flow guide body and a mounting base arranged on the flow guide body. The flow guide body is provided with the air intake interface, the air release interface, the air bag interface, and the reserved interface, and the first mounting hole is formed in the mounting base.

Further, the flow guide piece further includes a plug. The plug can block the reserved interface.

According to another aspect of the present disclosure, an air bag massage device is provided. The air bag massage device includes an air bag, an inflation assembly, a current detector, and a controller. The inflation assembly includes an air pump and a low-noise electromagnetic valve assembly, the low-noise electromagnetic valve assembly is the low-noise electromagnetic valve assembly provided above, an air intake interface of the low-noise electromagnetic valve assembly can be in communication with the air pump, and air bag interfaces of the low-noise electromagnetic valve assembly are in communication with the air bag. The current detector is connected with the air pump and can detect a current value of the air pump so as to obtain an inflation pressure of the air pump. The controller is connected with the air pump, the low-noise electromagnetic valve assembly, and the current detector, so as to control working states of the air pump and the low-noise electromagnetic valve assembly according to the current value of the air pump detected by the current detector.

Further, the current detector includes a sampling resistor configured to detect the current value of the air pump. The air bag massage device further includes a control box and a Printed Circuit Board (PCB) arranged in the control box, on which the controller and the sampling resistor are arranged.

Further, a plurality of air bags are provided, and the low-noise electromagnetic valve assembly includes a plurality of air bag interfaces, each of the air bag interfaces being in communication with a corresponding air bag.

Further, the inflation assembly further includes a normally closed air valve. The normally closed air valve has an air valve inlet and an air valve outlet, the air valve inlet is in communication with one of the plurality of the air bag interfaces, and the air valve outlet is in communication with the air bag corresponding to the one of the plurality of the air bag interfaces.

According to still another aspect of the present disclosure, a control method for an air bag massage device is provided for controlling the air bag massage device, where the air bag massage device is the air bag massage device provided above. The control method for the air bag massage device includes: inflating an air bag by an air pump, and detecting a current value of the air pump by a current detector so as to obtain an inflation pressure of the air pump; when the inflation pressure of the air pump reaches a preset pressure, deflating the air bag; and repeating inflation and deflation steps to enable the air bag to complete at least one inflation and deflation operation.

Further, a plurality of air bags are provided, the low-noise electromagnetic valve assembly has a plurality of air bag interfaces in communication with the plurality of air bags in a one-to-one correspondence manner, and the plurality of air bags include a first air bag group and a second air bag group. The control method includes a first mode, and when the control method uses the first mode, and the inflation pressure of the air bag reaches the preset pressure, a step of deflating the air bag includes: when the first air bag group is inflated until an inflation pressure of the first air bag group reaches the preset pressure, deflating the first air bag group and inflating the second air bag group, and when an inflation pressure of the second air bag group reaches the preset pressure, deflating the second air bag group and inflating the first air bag group.

Further, a plurality of air bags are provided, and the low-noise electromagnetic valve assembly has a plurality of air bag interfaces in communication with the plurality of air bags in a one-to-one correspondence manner. The control method includes a second mode, and when the control method uses the second mode, and after a step of repeating the inflation and deflation steps to enable the air bag to complete at least one inflation and deflation operation, the control method for the air bag massage device further includes: sequentially performing the inflation and deflation steps on the plurality of air bags.

Further, a plurality of air bags are provided, and the low-noise electromagnetic valve assembly has a plurality of air bag interfaces in communication with the plurality of air bags in a one-to-one correspondence manner. The control method includes a third mode, and when the control method uses the third mode, the step of inflating the air bag by the air pump includes: sequentially inflating the plurality of air bags by the air pump. When the inflation pressure of the air bag reaches the preset pressure, the step of deflating the air bag includes: sequentially deflating the plurality of air bags when the inflation pressure of the air bag reaches the preset pressure.

Further, a plurality of air bags are provided, and the low-noise electromagnetic valve assembly has a plurality of air bag interfaces in communication with the plurality of air bags in a one-to-one correspondence manner. The control method includes a fourth mode, and when the control method uses the fourth mode, and before the step of inflating the air bag by the air pump, the control method for the air bag massage device further includes: obtaining parameters of the air bag, where the parameters of the air bag include the preset pressure, a deflation time of the air bag, and the number of inflation and deflation times of the air bag.

Further, after the step of repeating the inflation and deflation steps to enable the air bag to complete at least one inflation and deflation operation, the control method for the air bag massage device further includes: obtaining updated parameters of the air bag.

Further, a plurality of air bags are provided, the low-noise electromagnetic valve assembly has a plurality of air bag interfaces in communication with the plurality of air bags in a one-to-one correspondence manner, and the plurality of air bags include a first air bag group and a second air bag group. The control method includes a first mode, and when the control method uses the first mode, and the inflation pressure of the air bag reaches the preset pressure, the step of deflating the air bag includes: when the first air bag group is inflated until the inflation pressure of the first air bag group reaches the preset pressure, deflating the first air bag group and inflating the second air bag group, and when the inflation pressure of the second air bag group reaches the preset pressure, deflating the second air bag group and inflating the first air bag group. The control method includes a second mode, and when the control method uses the second mode, and after the step of repeating the inflation and deflation steps to enable the air bag to complete at least one inflation and deflation operation, the control method for the air bag massage device further includes: sequentially performing the inflation and deflation steps on the plurality of air bags. The control method includes a third mode, and when the control method uses the third mode, the step of inflating the air bag by the air pump includes: sequentially inflating the plurality of air bags by the air pump. When the inflation pressure of the air bag reaches the preset pressure, the step of deflating the air bag includes: sequentially deflating the plurality of air bags when the inflation pressure of the air bag reaches the preset pressure. The control method includes a fifth mode, and when the control method uses the fifth mode, the fifth mode includes alternately cycling at least two of the first mode, the second mode, and the third mode.

By applying the technical solution of the present disclosure, the air bag massage device includes the air bag, the inflation assembly, the current detector, and the controller. When a user applies the air bag massage device for massage, and the air bag needs to be inflated, the air intake interface is in communication with the air pump, the air bag interface is in communication with the air bag, the controller controls the air bag interface of the low-noise electromagnetic valve assembly to be in communication with the air intake interface, and the controller controls the air pump to start to inflate the air bag. The gas flows into the air bag through the air intake interface and the air bag interface, and the current value of the air pump can be detected by the current detector, so that the inflation pressure of the air pump can be obtained. Because the air pump is in communication with the air bag, the inflation pressure of the air pump is equal to the pressure in the air bag, and then the pressure in the air bag may be detected by the current detector, so that the air bag interface of the low-noise electromagnetic valve assembly is controlled by the controller to be in communication with the air release interface according to the current value of the air pump detected by the current detector, and then the air bag is deflated. Because the pressure in the air bag is detected by the current detector, the pressure in the air bag may not exceed the preset pressure of the air bag, that is, air exhaust is preformed, and compared with a manner of detecting the pressure in the air bag by an air pressure sensor, it is not necessary to arrange a complex air path, so that the pressure of the air bag may be obtained in a simple structure, and the cost is reduced.

### BRIEF DESCRIPTION OF THE DRAWINGS

The drawings of the specification, which constitute a part of the present disclosure, are intended to provide a further understanding of the present disclosure, and the exemplary embodiments of the present disclosure and the description thereof are intended to explain the present disclosure and do not constitute an undue limitation on the present disclosure. In the drawings:

FIG. 1 shows a schematic logic diagram of a pneumatic massage system according to an embodiment of the present disclosure.

FIG. 2 shows a schematic structural diagram of a connection between an electromagnetic valve body and a flow guide piece according to an embodiment of the present disclosure.

FIG. 3 shows a schematic structural diagram of a silencer according to an embodiment of the present disclosure.

FIG. 4 shows a characteristic curve diagram of an air pump of an air bag massage device according to an embodiment of the present disclosure.

FIG. 5 shows a schematic structural diagram of an air bag massage device according to an embodiment of the present disclosure.

FIG. 6 shows a flowchart of a control method for an air bag massage device according to an embodiment of the present disclosure.

Herein, the above drawings include the following reference signs.
1. Electromagnetic valve body;
2. Flow guide piece; 21. Flow guide body; 211. Air intake interface; 212. Air release interface; 213. Air bag interface; 214. Reserved interface; 22. Mounting base; 221. First mounting hole;
3. Silencer; 31. Housing; 311. Silencer chamber; 312. Silencing air outlet; 313. Silencing air inlet; 32. Silencer cotton;
4. Air bag;
5. Inflation assembly; 51. Air pump; 52. Normally closed air valve;
6. Control box.

### DETAILED DESCRIPTION OF THE EMBODIMENTS

The technical solutions in embodiments of the present disclosure will be clearly and completely described below in conjunction with the drawings in the embodiments of the present disclosure. It is apparent that the described embodiments are only part of the embodiments of the present disclosure but not all of the embodiments. The following description of at least one exemplary embodiment is only illustrative actually, and in no way serves as any limitation on the present disclosure or application or use thereof. All other embodiments obtained by those ordinary skill in the art on the basis of the embodiments of the present disclosure without creative efforts are within the scope of protection of the present disclosure.

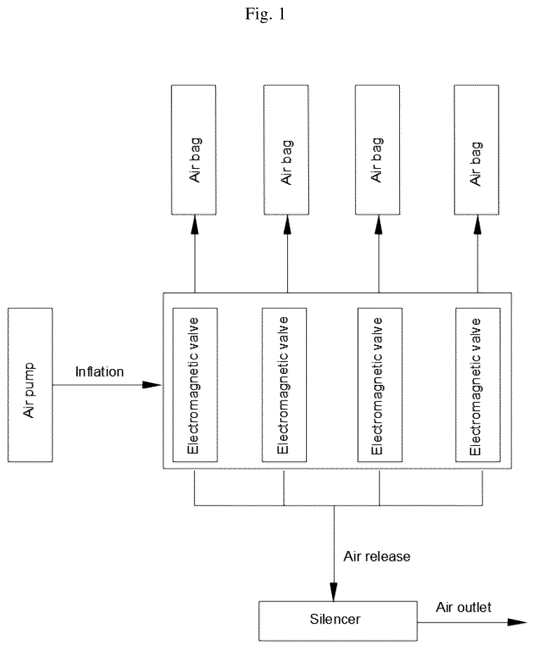

As shown in FIG. 1, the embodiments of the present disclosure provide a low-noise electromagnetic valve assembly. As shown in FIG. 1 to FIG. 3, the low-noise electromagnetic valve assembly includes an electromagnetic valve body 1, a flow guide piece 2, and a silencer 3. The flow guide piece 2 is connected with the electromagnetic valve body 1, and the flow guide piece 2 includes an air intake interface 211, an air release interface 212, an air bag interface 213, and a reserved interface 214. The air intake interface 211 can be in communication with an air pump, the air bag interface 213 is in communication with an air bag, the electromagnetic valve body 1 is configured to enable the air bag interface 213 to be in communication with the air intake interface 211 or the air release interface 212, the reserved interface 214 can be in communication with the air bag interface 213, and the reserved interface 214 is configured for air release. The air release interface 212 is in communication with the silencer 3, the silencer 3 is provided with a silencing air outlet 312, and the silencer 3 is configured to reduce air release noise. Specifically, a plurality of air bags are provided, a plurality of air bag interfaces 213 are provided, and the plurality of air bags are in communication with the plurality of air bag interfaces 213 in a one-to-one correspondence manner. In the embodiment, four air bag interfaces 213, one air intake interface 211, one air release interface 212, and one reserved interface 214 are provided, and the electromagnetic valve body 1 includes a plurality of electromagnetic valves. The plurality of electromagnetic valves are in one-to-one correspondence with the plurality of air bag interfaces 213, and one electromagnetic valve controls one air bag interface 213.

According to the low-noise electromagnetic valve assembly provided in the embodiment, when the air bag needs to be inflated, the air intake interface 211 is in communication with the air pump, the air bag interface 213 is in communication with the air bag, the electromagnetic valve body 1 controls the air bag interface 213 to be in communication with the air intake interface 211, the air pump starts inflation, and gas flows into the air bag through the air intake interface 211 and the air bag interface 213, thereby filling the air bag. When the air bag does not need to be inflated, the air pump is disconnected from the air intake interface 211, the air bag interface 213 is in communication with the air release interface 212, the gas in the air bag flows into the silencer 3 through the air bag interface 213 and the air release interface 212, and finally flows out through the silencing air outlet 312 of the silencer 3, so that the air release noise is reduced by the silencer 3. According to the low-noise electromagnetic valve assembly provided in the embodiment, the gas in the plurality of air bags is converged to one air release interface 212 and flows to one silencer 3, so that the deflation sound is reduced, and the usage experience is improved. Only one silencer 3 is provided, which reduces the production cost. Moreover, the reserved interface 214 is further provided, and when the air release speed is too slow, the reserved interface 214 may be enabled for air release, so that the air release speed of the air bag is increased, or when the air release interface 212 is damaged, the reserved interface 214 may be enabled for air release. The reserved interface 214 is provided, which improves the practicability of the low-noise electromagnetic valve assembly.

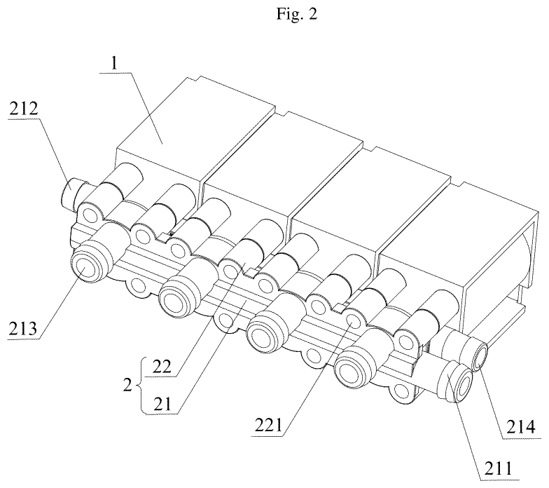

Specifically, as shown in FIG. 2, the flow guide piece 2 is detachably connected with the electromagnetic valve body 1 through a connecting piece, and when the electromagnetic valve body 1 or the flow guide piece 2 is damaged, disassembly and replacement are facilitated. More specifically, a first mounting hole 221 is formed in the flow guide piece 2, a second mounting hole is formed in the electromagnetic valve body 1, and the connecting piece passes through the first mounting hole 221 and the second mounting hole. In the embodiment, the connecting piece is a screw, the second mounting hole is a threaded hole, and the screw sequentially passes through the first mounting hole 221 and the second mounting hole and is in threaded connection with the second mounting hole, thereby achieving the detachable connection between the flow guide piece 2 and the electromagnetic valve body 1.

Specifically, as shown in FIG. 2, the flow guide piece 2 includes a flow guide body 21 and a mounting base 22 arranged on the flow guide body 21. The flow guide body 21 is provided with the air intake interface 211, the air release interface 212, the air bag interface 213, and the reserved interface 214, and the first mounting hole 221 is formed in the mounting base 22. More specifically, the flow guide body 21 and the mounting base 22 are integrally formed to facilitate machining. In the embodiment, the air intake interface 211 and the reserved interface 214 are arranged on a right side (right as shown in FIG. 2) of the flow guide body 21, the air release interface 212 is arranged on a left side (left as shown in FIG. 2) of the flow guide body 21, the mounting base 22 is arranged above the flow guide body 21, and one end of the mounting base 22 can abut against an outer wall of the electromagnetic valve body 1. The air bag interface 213 is arranged on one side, away from the electromagnetic valve body 1, of the flow guide body 21.

Specifically, the flow guide piece 2 further includes a plug. The plug can block the reserved interface 214. When air release needs to be performed by using the reserved interface 214, a worker or the user may remove the plug.

Specifically, an intake line is arranged in the flow guide body 21 of the flow guide piece 2, the intake line can be in communication with the air bag interface 213 and the air intake interface 211, and gas provided by the air pump can flow into the air bag through the air intake interface 211, the intake line, and the air bag interface 213, thereby inflating the air bag.

Specifically, an exhaust line is arranged in the flow guide body 21 of the flow guide piece 2, the exhaust line can be in communication with the air bag interface 213 and the air release interface 212, and gas in the air bag can flow out of the silencer 3 through the air bag interface 213, the exhaust line, and the air release interface 212, and finally flows out through the silencing air outlet 312 of the silencer 3.

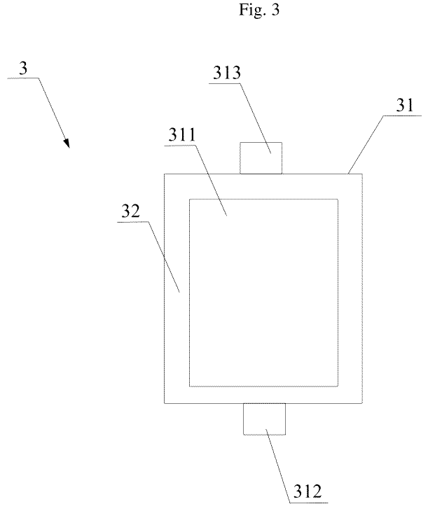

Further, as shown in FIG. 3, the silencer 3 includes a housing 31 and silencer cotton 32. A silencer chamber 311 is arranged in the housing 31, the air release interface 212 is in communication with the silencer chamber 311, and the housing 31 is provided with the silencing air outlet 312. The silencer cotton 32 is arranged in the silencer chamber 311. The gas flows into the silencer chamber 311 through the air release interface 212, and the silencer cotton 32 absorbs airflow in the silencer chamber 311, thereby reducing standing waves and resonance, and reducing the air release noise. The gas finally flows out through the silencing air outlet 312. Specifically, the housing 31 is provided with the silencing air inlet 313, and the air release interface 212 is in communication with the silencer chamber 311 through the silencing air inlet 313, so that the gas conveniently flows into the silencer chamber 311. In the embodiment, the silencer cotton 32 is located in the silencer chamber 311 and attached to an inner wall of the silencer chamber 311. In other embodiments, the silencer cotton 32 may be arranged in other positions in the silencer chamber 311, as long as it can absorb sound.

Specifically, as shown in FIG. 3, buffer holes are respectively formed in the silencing air inlet 313 and the silencing air outlet 312, the gas may flow out through the buffer holes, and the buffer holes are configured to enable the gas to smoothly flow out. More specifically, the buffer holes are formed in cross sections of the silencing air inlet 313 and the silencing air outlet 312, and the gas can flow into the silencer chamber 311 through an end (namely one end, away from the housing 31, of the silencing air inlet 313) of the silencing air inlet 313 and the buffer hole, or the gas in the silencer chamber 311 can flow out through the buffer hole and an end (namely one end, away from the housing 31, of the silencing air outlet 312) of the silencing air outlet 312. The buffer holes are formed, so that the gas flowing in or out is slowed down. More specifically, a plurality of buffer holes are formed in the cross section of the silencing air inlet 313 and the silencing air outlet 312 to control the flow rate of the gas.

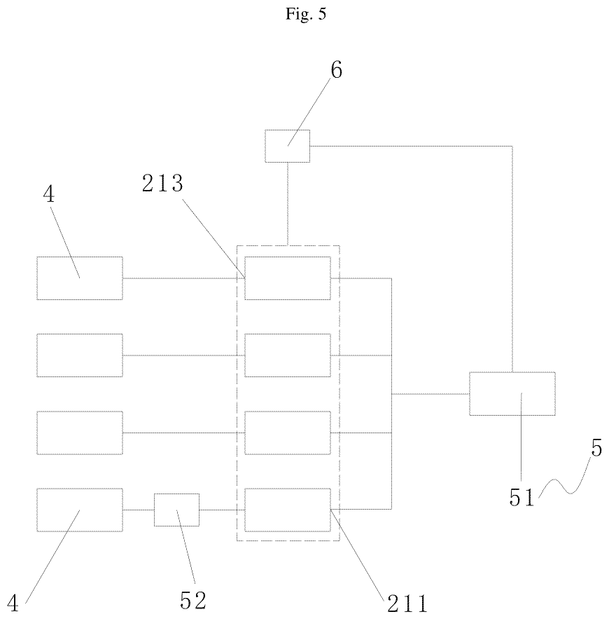

As shown in FIG. 5, another embodiment of the present disclosure provides an air bag massage device. The air bag massage device includes an air bag 4, an inflation assembly 5, a current detector, and a controller. The inflation assembly 5 includes an air pump 51 and a low-noise electromagnetic valve assembly, the low-noise electromagnetic valve assembly is the low-noise electromagnetic valve assembly provided above, an air intake interface 211 of the low-noise electromagnetic valve assembly is in communication with the air pump 51, and air bag interfaces 213 of the low-noise electromagnetic valve assembly are in communication with the air bag 4. The current detector is connected with the air pump 51 and can detect a current value of the air pump 51 so as to obtain an inflation pressure of the air pump 51. The controller is connected with the air pump 51, the low-noise electromagnetic valve assembly, and the current detector, so as to control working states of the air pump 51 and the low-noise electromagnetic valve assembly according to the current value of the air pump 51 detected by the current detector.

By applying the technical solution of the present disclosure, the air bag massage device includes the air bag 4, the inflation assembly 5, the current detector, and the controller. When a user applies the air bag massage device for massage, and the air bag 4 needs to be inflated, the air intake interface 211 is in communication with the air pump 51, the air bag interface 213 is in communication with the air bag 4, the controller controls the air bag interface 213 of the low-noise electromagnetic valve assembly to be in communication with the air intake interface 211, and the controller controls the air pump 51 to start to inflate the air bag 4. The gas flows into the air bag 4 through the air intake interface 211 and the air bag interface 213, and the current value of the air pump 51 can be detected by the current detector, so that the inflation pressure of the air pump 51 can be obtained. Because the air pump 51 is in communication with the air bag 4, the inflation pressure of the air pump 51 is equal to the pressure in the air bag 4, and then the pressure in the air bag 4 can be detected by the current detector, so that the air bag interface 213 of the low-noise electromagnetic valve assembly is controlled by the controller to be in communication with the air release interface 212 according to the current value of the air pump 51 detected by the current detector, and then the air bag 4 is deflated. Because the pressure in the air bag 4 is detected by the current detector, the pressure in the air bag 4 may not exceed the preset pressure of the air bag 4, that is, air exhaust is preformed, and compared with a manner of detecting the pressure in the air bag 4 by an air pressure sensor, it is not necessary to arrange a complex air path, so that the pressure of the air bag 4 may be obtained in a simple structure, and the cost is reduced.

It is to be noted that, compared with an inflation manner of setting an inflation time of the air bag 4, a manner of detecting the pressure in the air bag 4 is used, the massage strength of the air bag 4 may be set by adjusting the preset pressure of the air bag 4, so that users with different weights may obtain different usage experiences, and the users obtain a better usage experience.

The preset pressure of the air bag 4 refers to the inflation pressure set when the air bag 4 leaves the factory. In the embodiment, the preset pressure of the air bag 4 includes a first preset pressure of 150 mmHg, a second preset pressure of 200 mmHg, and a third preset pressure of 250 mmHg. The user may select and adjust the three preset pressures as needed, so as to obtain a satisfactory usage experience.

Moreover, the preset pressure of the air bag 4 is smaller than a limit pressure that the air bag 4 can bear, and the air bag 4 may be prevented from exploding by detecting the pressure in the air bag 4.

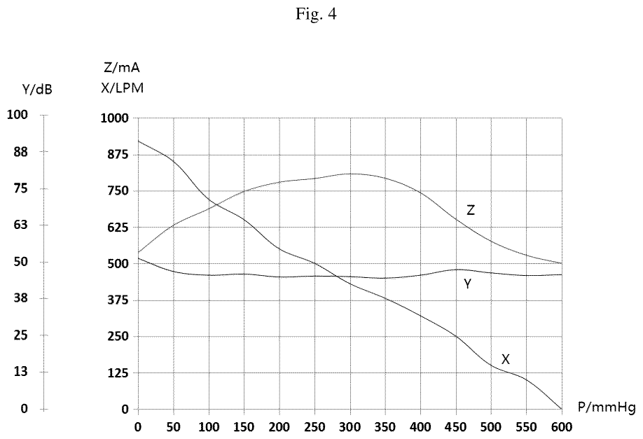

As shown in FIG. 4, a current characteristic curve of the air pump 51 indicates that as the air pressure in the air bag 4 increases, the current gradually increases, and when the air pressure exceeds a certain air pressure value, the current gradually decreases. Therefore, this characteristic may be used, and a pressure value of the air pump 51 is obtained by using the current value thereof before the current decreases. In this embodiment, the model of the air pump 51 is WP45-12V.

In FIG. 4, a curve X indicates that the flow of the airflow of the air pump 51 changes with the pressure thereof, a curve Y indicates that the noise of the air pump 51 changes with the pressure thereof, a curve Z indicates that the current of the air pump 51 changes with the pressure thereof, and P indicates the pressure of the air pump 51.

In the embodiment, the current detector includes a sampling resistor configured to detect the current value of the air pump 51. The air bag massage device further includes a control box 6 and a PCB arranged in the control box 6, on which the controller and the sampling resistor are arranged. A manner of arranging the controller and the sampling resistor on the PCB in the control box 6 has the advantages of simple structure and convenient arrangement.

In the embodiment, after the sampling resistor collects a working current of the air pump 51, voltage signals at both ends of the sampling resistor may be amplified through an amplifying circuit, the amplified voltage is collected through a digital-to-analog converter, and the amplified signal is read out to calculate the current value of the air pump 51.

Specifically, the controller is a Microcontroller Unit (MCU) chip arranged on the PCB.

As shown in FIG. 5, a plurality of air bags 4 are provided, and the low-noise electromagnetic valve assembly includes a plurality of air bag interfaces 213, each of the air bag interfaces 213 being in communication with a corresponding air bag 4. By arranging the plurality of air bags 4, different air bags 4 may correspond to different positions of the user, and different air bags 4 are in different working states, so as to massage different parts according to the actual situation of the user.

In the embodiment, the air bag massage device includes four air bags 4, the four air bags 4 are sequentially arranged from the waist of the user to the back of the user, and the waist and the back of the user may be massaged by using the four air bags 4.

As shown in FIG. 5, the inflation assembly 5 further includes a normally closed air valve 52. The normally closed air valve 52 has an air valve inlet and an air valve outlet, the air valve inlet is in communication with one of the plurality of air bag interfaces 213, and the air valve outlet is in communication with the air bag 4 corresponding to the one of the plurality of the air bag interfaces 213. The normally closed air valve 52 is used, when the air bag 4 works, the air valve may be powered on, and the airflow in the air pump 51 may enter the corresponding air bag 4 through the air bag interface 213 and the normally closed air valve 52, so as to inflate the air bag 4. When the air bag 4 does not work, the air valve is powered off to seal the gas in the corresponding air bag 4, so as to support the waist and other relatively low-lying positions of the user.

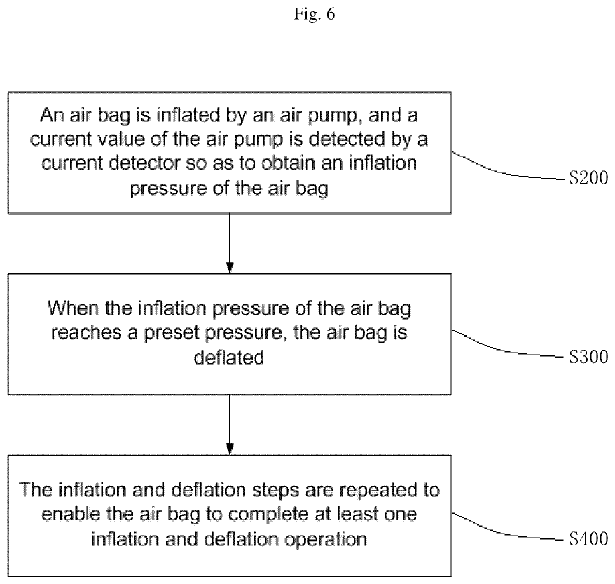

As shown in FIG. 6, another embodiment of the present disclosure provides a control method for an air bag massage device for controlling the air bag massage device. The air bag massage device is the air bag massage device provided above, and the control method for the air bag massage device includes the following operations.

At S200, an air bag 4 is inflated by an air pump 51, and a current value of the air pump 51 is detected by a current detector so as to obtain an inflation pressure of the air bag 4.

At S300, when the inflation pressure of the air bag 4 reaches a preset pressure, the air bag 4 is deflated.

At S400, inflation and deflation steps are repeated to enable the air bag 4 to complete at least one inflation and deflation operation.

By applying the control method provided in the present disclosure, in the process of inflating the air bag 4 by the air pump 51, the current value of the air pump 51 is detected by the current detector, and the inflation pressure of the air pump 51 is obtained through a chart, so that the pressure in the air bag 4 is obtained, and the detected pressure value is compared with the preset pressure, thereby preventing the air bag 4 from being overinflated. When the inflation pressure of the air bag 4 reaches the preset pressure, the air bag 4 is deflated, and then the height of the air bag 4 may be adjusted through inflation and deflation of the air bag 4, so that the user can obtain a massage experience. Moreover, through multiple inflation and deflation operations of the air bag 4, the user may obtain a continuous massage experience to relax the body and achieve a satisfactory usage experience.

In S200, the current value of the air pump 51 is detected by the current detector so as to obtain the inflation pressure of the air bag 4, and the detected pressure value of the air bag 4 may be compared with the preset pressure, thereby preventing the air bag 4 from being overinflated.

In the embodiment, In S300, when the inflation pressure of the air pump 4 reaches the preset pressure, the air bag 4 is deflated, and then the height of the air bag 4 may be adjusted through inflation and deflation of the air bag 4, so that the user can obtain a massage experience.

Specifically, in S400, the inflation and deflation steps are repeated to enable the air bag 4 to complete multiple inflation and deflation operations, and then the user may obtain a continuous massage experience to relax the body and achieve a satisfactory usage experience.

A plurality of air bags 4 are provided, the low-noise electromagnetic valve assembly has a plurality of air bag interfaces 213 in communication with the plurality of air bags 4 in a one-to-one correspondence manner, and the plurality of air bags 4 include a first air bag group and a second air bag group. The control method includes a first mode, and when the control method uses the first mode, and the inflation pressure of the air bag 4 reaches a preset pressure, S300 of deflating the air bag includes the following operation.

When the first air bag group is inflated until an inflation pressure of the first air bag group reaches the preset pressure, the first air bag group is deflated and the second air bag group is inflated, and when an inflation pressure of the second air bag group reaches the preset pressure, the second air bag group is deflated and the first air bag group is inflated.

By using the first mode, through alternate inflation and deflation of the first air bag group and the second air bag group, the user may feel the continuous massage feeling, so as to achieve a satisfactory massage effect.

In the embodiment, the first air bag group includes two air bags 4, and the second air bag group includes two air bags 4.

Specifically, a plurality of air bags 4 are provided, and the low-noise electromagnetic valve assembly has a plurality of air bag interfaces 213 in communication with the plurality of air bags 4 in a one-to-one correspondence manner. The control method includes a second mode, and when the control method uses the second mode, and after S400 of repeating the inflation and deflation steps to enable the air bag 4 to complete at least one inflation and deflation operation, the control method for the air bag massage device further includes the following operation.

Inflation and deflation steps are sequentially performed on the plurality of air bags 4.

By using the second mode, after cyclic inflation and deflation operations are performed on a first air bag 4, cyclic inflation and deflation operations are sequentially performed on the second, third, and fourth air bags 4, so that a certain part of the user may experience a continuous impact massage, each part of the user may experience a continuous impact massage effect, and the user is satisfied.

In the second mode, the deflation operation of each of the air bags 4 is controlled by a first deflation time, and the air bag 4 is inflated after the first deflation time is reached.

Specifically, a plurality of air bags 4 are provided, and the low-noise electromagnetic valve assembly has a plurality of air bag interfaces 213 in communication with the plurality of air bags 4 in a one-to-one correspondence manner. The control method includes a third mode, and when the control method uses the third mode, S200 of inflating the air bag 4 by the air pump 51 includes: sequentially inflating the plurality of air bags 4 by the air pump 51. When the inflation pressure of the air bag 4 reaches the preset pressure, S300 of deflating the air bag 4 includes: sequentially deflating the plurality of air bags 4 when the inflation pressure of the air bag 4 reaches the preset pressure.

By using the third mode, by sequentially inflating the plurality of air bags 4 and sequentially deflating the plurality of air bags 4, the waist and the back of the user may feel a wavy massage effect, and the user is satisfied.

Specifically, in the third mode, the deflation operation of the air bag 4 is controlled by a second deflation time, and the next air bag 4 is deflated after the second deflation time is reached.

It is to be noted that, in the first mode, the second mode, and the third mode, before massage, the user may select between the first preset pressure, the second preset pressure, and the third preset pressure, so that the user may set according to the habits of the user.

A plurality of air bags 4 are provided, and the low-noise electromagnetic valve assembly has a plurality of air bag interfaces 213 in communication with the plurality of air bags 4 in a one-to-one correspondence manner. The control method includes a fourth mode, and when the control method uses the fourth mode, and before S200 of inflating the air bag 4 by the air pump 51, the control method for the air bag massage device further includes the following operation.

Parameters of the air bag 4 are obtained. The parameters of the air bag 4 include the preset pressure, a deflation time of the air bag 4, and the number of inflation and deflation times of the air bag 4.

By using the fourth mode, before massage, the parameters of the air bag 4 are set, so that the user may adjust the massage strength and the massage time of the air bag 4 according to his/her own willingness, and the user is satisfied.

In the fourth mode, after S400 of repeating the inflation and deflation steps to enable the air bag 4 to complete at least one inflation and deflation operation, the method includes the following operation.

Obtaining updated parameters of the air bag 4.

By using the updated parameters of the air bag 4 obtained in the step, the user may adjust the set parameters of the air bag 4, so that the user obtains a more satisfactory usage experience.

A plurality of air bags 4 are provided, the low-noise electromagnetic valve assembly has a plurality of air bag interfaces 213 in communication with the plurality of air bags 4 in a one-to-one correspondence manner, and the plurality of air bags 4 include a first air bag group and a second air bag group. The control method includes a first mode, and when the control method uses the first mode, and the inflation pressure of the air bag 4 reaches the preset pressure, the step of deflating the air bag 4 includes: when the first air bag group is inflated until an inflation pressure of the first air bag group reaches the preset pressure, deflating the first air bag group and inflating the second air bag group, and when an inflation pressure of the second air bag group reaches the preset pressure, deflating the second air bag group and inflating the first air bag group. The control method includes a second mode, and when the control method uses the second mode, and after the step of repeating the inflation and deflation steps to enable the air bag 4 to complete at least one inflation and deflation operation, the control method for the air bag massage device further includes: sequentially performing the inflation and deflation steps on the plurality of air bags 4. The control method includes a third mode, and when the control method uses the third mode, the step of inflating the air bag 4 by the air pump 51 includes: sequentially inflating the plurality of air bags 4 by the air pump 51. When the inflation pressure of the air bag 4 reaches the preset pressure, the step of deflating the air bag 4 includes: sequentially deflating the plurality of air bags 4 when the inflation pressure of the air bag 4 reaches the preset pressure. The control method includes a fifth mode, and when the control method uses the fifth mode, the fifth mode includes alternately cycling at least two of the first mode, the second mode, and the third mode.

By using the fifth mode, the user may obtain different massage experiences to achieve a satisfactory massage effect.

In the fifth mode, the user may freely adjust the parameters of the air bag 4 in the first mode, the second mode, and the third mode, so that the user adjusts the massage strength and the massage time of the air bag 4 according to his/her own willingness.

It is to be noted that, in the fourth mode and the fifth mode, the user may set the parameters of the air bag 4 through the control box, or may set through a client of a built-in program, and the client may be a terminal such as a mobile phone or a computer.

The above is only the preferred embodiments of the present disclosure, and is not intended to limit the present disclosure, and for those of ordinary skill in the art, various modifications and changes may be made to the present disclosure. Any modifications, equivalent substitutions, improvements, etc. within the spirit and scope of the present disclosure shall be included in the scope of protection of the present disclosure.

What is claimed is:

1. A low-noise electromagnetic valve assembly, comprising:
an electromagnetic valve body (1);
a flow guide piece, connected with the electromagnetic valve body, the flow guide piece comprising an air intake interface, an air release interface, an air bag interface, and a reserved interface, wherein the air intake interface is in communication with an air pump, the air bag interface is in communication with an air bag, the electromagnetic valve body is configured to enable the air bag interface to be in communication with the air intake interface or the air release interface, the reserved interface can be in communication with the air bag interface, and the reserved interface is configured for air release; and
a silencer, wherein the air release interface is in communication with the silencer, the silencer is provided with a silencing air outlet, and the silencer is configured to reduce air release noise.

2. The low-noise electromagnetic valve assembly according to claim 1, wherein an intake line is arranged in the flow guide piece, the intake line is in communication with the air bag interface and the air intake interface, and gas can flow into the air bag through the air intake interface, the intake line, and the air bag interface.

3. The low-noise electromagnetic valve assembly according to claim 1, wherein an exhaust line is arranged in the flow guide piece, the exhaust line can be in communication with the air bag interface and the air release interface, and gas in the air bag can flow out through the air bag interface, the exhaust line, and the air release interface.

4. The low-noise electromagnetic valve assembly according to claim 1, wherein the silencer comprises:
a housing, wherein a silencer chamber is arranged in the housing, the air release interface is in communication with the silencer chamber, and the housing is provided with the silencing air outlet; and
silencer cotton, wherein the silencer cotton is arranged in the silencer chamber.

5. The low-noise electromagnetic valve assembly according to claim 4, wherein the housing is provided with a silencing air inlet, and the air release interface is in communication with the silencer chamber through the silencing air inlet, buffer holes are respectively formed in the silencing air inlet and the silencing air outlet, and the buffer holes are configured to enable the gas to smoothly flow out.

6. (canceled)

7. The low-noise electromagnetic valve assembly according to claim 1, wherein the flow guide piece is detachably connected with the electromagnetic valve body through a connecting piece.

8. The low-noise electromagnetic valve assembly according to claim 7, wherein a first mounting hole is formed in the flow guide piece, a second mounting hole is formed in the electromagnetic valve body, and the connecting piece passes through the first mounting hole and the second mounting hole.

9. The low-noise electromagnetic valve assembly according to claim 8, wherein the flow guide piece comprises a flow guide body and a mounting base arranged on the flow guide body, wherein the flow guide body is provided with the air intake interface, the air release interface, the air bag interface, and the reserved interface, and the first mounting hole is formed in the mounting base.

10. The low-noise electromagnetic valve assembly according to claim 1, wherein the flow guide piece further comprises a plug, wherein the plug can block the reserved interface.

11. An air bag massage device, comprising:
an air bag;
an inflation assembly, comprising an air pump and a low-noise electromagnetic valve assembly, wherein the low-noise electromagnetic valve assembly is the low-noise electromagnetic valve assembly according to claims 1, an air intake interface of the low-noise electromagnetic valve assembly can be in communication with the air pump, and air bag interfaces of the low-noise electromagnetic valve assembly can be in communication with the air bag;
a current detector, which is connected with the air pump and can detect a current value of the air pump so as to obtain an inflation pressure of the air pump; and
a controller, connected with the air pump, the low-noise electromagnetic valve assembly, and the current detector, so as to control working states of the air pump and the low-noise electromagnetic valve assembly according to the current value of the air pump detected by the current detector.

12. The air bag massage device according to claim 11, wherein the current detector comprises a sampling resistor configured to detect the current value of the air pump;
the air bag massage device further comprises a control box and a Printed Circuit Board (PCB) arranged in the control box, on which the controller and the sampling resistor are arranged.

13. The air bag massage device according to claim 11, wherein a plurality of air bags are provided, and the low-noise electromagnetic valve assembly comprises a plurality of air bag interfaces, each of the air bag interfaces being in communication with a corresponding air bag.

14. The air bag massage device according to claim 13, wherein the inflation assembly further comprises a normally closed air valve, wherein the normally closed air valve has an air valve inlet and an air valve outlet, the air valve inlet is in communication with one of the plurality of the air bag interfaces, and the air valve outlet is in communication with the air bag corresponding to the one of the plurality of the air bag interfaces.

15. A control method for an air bag massage device for controlling the air bag massage device, wherein the air bag massage device is the air bag massage device according to claim 11, and the control method for the air bag massage device comprises:
inflating an air bag by an air pump, and detecting a current value of the air pump by a current detector so as to obtain an inflation pressure of the air bag;
when the inflation pressure of the air bag reaches a preset pressure, deflating the air bag; and
repeating inflation and deflation steps to enable the air bag to complete at least one inflation and deflation operation.

16. The control method for the air bag massage device according to claim 15, wherein a plurality of air bags are provided, a low-noise electromagnetic valve assembly has a plurality of air bag interfaces in communication with the plurality of air bags in a one-to-one correspondence manner, and the plurality of air bags comprise a first air bag group and a second air bag group; the control method comprises a first mode, and when the control method uses the first mode, and the inflation pressure of the air bag reaches the preset pressure, a step of deflating the air bag comprises:
when the first air bag group is inflated until an inflation pressure of the first air bag group reaches the preset pressure, deflating the first air bag group and inflating the second air bag group, and when an inflation pressure of the second air bag group reaches the preset pressure, deflating the second air bag group and inflating the first air bag group.

17. The control method for the air bag massage device according to claim 15, wherein a plurality of air bags are provided, a low-noise electromagnetic valve assembly has a plurality of air bag interfaces in communication with the plurality of air bags in a one-to-one correspondence manner; the control method comprises a second mode, and when the control method uses the second mode, and after a step of repeating the inflation and deflation steps to enable the air bag to complete at least one inflation and deflation operation, the control method for the air bag massage device further comprises:
sequentially performing the inflation and deflation steps on the plurality of air bags.

18. The control method for the air bag massage device according to claim 15, wherein a plurality of air bags are provided, a low-noise electromagnetic valve assembly has a plurality of air bag interfaces in communication with the plurality of air bags in a one-to-one correspondence manner; the control method comprises a third mode, and when the control method uses the third mode,
the step of inflating the air bag by the air pump comprises: sequentially inflating the plurality of air bags by the air pump; and
when the inflation pressure of the air bag reaches the preset pressure, the step of deflating the air bag comprises: sequentially deflating the plurality of air bags when the inflation pressure of the air bag reaches the preset pressure.

19. The control method for the air bag massage device according to claim 15, wherein a plurality of air bags are provided, a low-noise electromagnetic valve assembly has a plurality of air bag interfaces in communication with the plurality of air bags in a one-to-one correspondence manner; the control method comprises a fourth mode, and when the control method uses the fourth mode, and before the step of inflating the air bag by the air pump, the control method for the air bag massage device further comprises:
obtaining parameters of the air bag, wherein the parameters of the air bag comprise the preset pressure, a deflation time of the air bag, and the number of inflation and deflation times of the air bag.

20. The control method for the air bag massage device according to claim 19, wherein after the step of repeating the inflation and deflation steps to enable the air bag to complete at least one inflation and deflation operation, the control method for the air bag massage device further comprises:
obtaining updated parameters of the air bag.

21. The control method for the air bag massage device according to claim 15, wherein a plurality of air bags are provided, a low-noise electromagnetic valve assembly has a plurality of air bag interfaces in communication with the plurality of air bags in a one-to-one correspondence manner, and the plurality of air bags comprise a first air bag group and a second air bag group;
the control method comprises a first mode, and when the control method uses the first mode, and the inflation pressure of the air bag reaches the preset pressure, the step of deflating the air bag comprises: when the first air bag group is inflated until the inflation pressure of the first air bag group reaches the preset pressure, deflating the first air bag group and inflating the second air bag group, and when the inflation pressure of the second air bag group reaches the preset pressure, deflating the second air bag group and inflating the first air bag group;
the control method comprises a second mode, and when the control method uses the second mode, and after the step of repeating the inflation and deflation steps to enable the air bag to complete at least one inflation and deflation operation, the control method for the air bag massage device further comprises: sequentially performing the inflation and deflation steps on the plurality of air bags;
the control method comprises a third mode, and when the control method uses the third mode, the step of inflating the air bag by the air pump comprises: sequentially inflating the plurality of air bags by the air pump; when the inflation pressure of the air bag reaches the preset pressure, the step of deflating the air bag comprises: sequentially deflating the plurality of air bags when the inflation pressure of the air bag reaches the preset pressure; and
the control method comprises a fifth mode, and when the control method uses the fifth mode, the fifth mode comprises alternately cycling at least two of the first mode, the second mode, and the third mode.
